(19) United States
(12) Patent Application Publication
(10) Pub. No.: US 2024/0176305 A1
(43) Pub. Date: May 30, 2024

(54) TIMEPIECE TESTING DEVICE

(71) Applicant: Omega SA, Biel/Bienne (CH)

(72) Inventor: José LEHMANN, Bevaix (CH)

(73) Assignee: Omega SA, Biel/Bienne (CH)

(21) Appl. No.: 18/240,944

(22) Filed: Aug. 31, 2023

(30) Foreign Application Priority Data
Nov. 24, 2022 (EP) 22209439.3

(51) Int. Cl. G04D 7/00

(52) U.S. Cl. CPC G04D 7/006

(57) ABSTRACT

A device (100) for testing a timepiece, including a case (1) receiving calottes (200) or watch heads (300), each calotte (200) enclosing a movement (400) and its projecting control member. The case (1) includes, removable and stackable on top of one another, a back, a frame (90) including at least one measuring support (500) forming a lower support for a calotte (200) or watch head (300), and an upper portion including a cover (10) with a locking element (16) for compressing an upper resilient element (80, 83) and holding each calotte (200) and/or each watch head (300). Each measuring support (500) is supported by a sole made of a resilient material (921) and carries an internal running sensor (510). Each movement (400) of the case (1) is phonically isolated from the other movements (400) by other resilient elements in the case (1).

### CROSS REFERENCE TO RELATED APPLICATIONS

This application claims priority to European Patent Application No. 22209439.3 filed Nov. 24, 2022, the entire contents of which are incorporated herein by reference.

### TECHNICAL FIELD OF THE INVENTION

The invention relates to a device for testing a timepiece, comprising at least one case arranged to receive calottes and/or watch heads, each said calotte enclosing a horological movement, a control member of which projects from said calotte, each said watch head enclosing such a horological movement, each said case comprising, removable and stackable on top of one another, a back, a frame comprising at least one measuring support arranged to constitute a lower support for said calotte or said watch head, and an upper portion comprising at least one cover provided with at least one locking element arranged to cooperate in a complementary manner with a locking structure included in said back in a closure and locking position of said case in which closure and locking position at least one upper resilient element interposed between said frame and said cover is compressed to hold each said calotte and/or each said watch head contained in said case.

The invention relates to the field of tests or adjustments of horological movements, watch heads and timepieces.

### TECHNOLOGICAL BACKGROUND

The document EP3410234B1 in the name of OMEGA SA describes a case receiving a plurality of well-protected watch heads, which can be contacted by a probe or microphone.

In the prior art, for the final tests of the manufacturing cycle, horological movements are arranged in cases or fittings, which are in turn arranged in compartments giving access to a microphone, or in the back of which a microphone mounted on a suspended structure is arranged. The movement comprises its winding stem surmounted by a crown, and the movements are each placed in their own compartment so that the crown comes into contact with the microphone. The ticking of the watch can thus be picked up, and the picked-up signal transmitted to a processing circuit.

When it is desired to take these measurements on a watch head, in particular to obtain measurements closer to real-life operation, it is difficult to proceed in the same way, as the stem with its crown is a delicate element that can be injured when the watch head is placed in the compartments. This problem is exacerbated when the watch head also includes push-buttons such as chronograph push-buttons.

An additional problem is that the shape, size and position of the crowns are not identical from one case to another, thereby requiring a multitude of different positions, which is neither practical nor economical.

It has also been proposed to place the watch head in a device so that the crystal comes into contact with the microphone. However, this solution is not satisfactory, as the microphone is in contact with the movement via the crystal and the crystal gasket, which dampens the acoustic wave and does not allow the movement to be listened to optimally. Another known problem concerns noise pollution, when carrying out a vibratory test, in particular an acoustic test, on a horological movement surrounded by other movements that are also operating.

### SUMMARY OF THE INVENTION

The aim of the invention is to improve the conditions for running tests at the end of the manufacturing cycle, both for movements that have not yet been fitted together, packaged in ad hoc cases, and for ready-to-use watch heads. The invention relates to a device based on the use of cases capable of enclosing these movements in calottes or watch heads, protecting them, orienting them in a measuring position, and acoustically isolating each of these movements from the other movements contained in the same case.

To this end, the invention relates to a timepiece test device according to claim 1.

Another aspect of the invention relates to a method for testing and/or adjusting a timepiece.

### BRIEF DESCRIPTION OF THE FIGURES

The aims, advantages and features of the invention will become clearer in the following detailed description, with reference to the appended drawings, where:

FIG. 1 shows a schematic perspective view of a case comprising a device according to the invention, in a particular variant which is by no means limiting, this case comprising, from bottom to top, a back, a belt and a cover, enclosing watch heads for transport and measurement thereof; this case is in a closure and locking position, in which the forced closure of the cover on the back, via the belt, as well as various resilient elements arranged under, around and on the watch heads to press them against measuring supports not visible in this figure. In a non-limiting variant, the watch heads are visible through a window in the belt. The back, belt and cover are fitted with gripping elements for manipulation by a robotic manipulator;

FIG. 2 shows a schematic perspective of the back of the case shown in FIG. 1, which includes a lower window for access to a printed circuit board. This back is fitted with columns, each of which has a groove at the top arranged to cooperate with one of the upper sliding drawers shown in FIG. 1. On its upper face, the back has two legs and two housings, arranged to facilitate precision stacking while imposing a particular angular stacking position;

FIG. 3 shows a schematic perspective view of the belt of the case in FIG. 1, which comprises, on either side of a protective cover for energy storage means, in this case batteries, two rows of watch heads, each watch head surrounded by a first lateral resilient element, and each row surrounded by a second lateral resilient element arranged to fit in a chamber of the belt and compress each first lateral resilient element around each watch head. A graphic symbol on one side of the belt identifies the type of product for which the belt is intended. Legs are visible at the back for stacking in cooperation with the back housings, a foolproof stud is visible at the top, and four housings are visible for stacking the cover;

FIG. 4 shows a schematic perspective view of the cover of the case shown in FIG. 1, which includes two sliding drawers for locking the case by compressing the resilient elements. Legs are visible on the lower portion for stacking in cooperation with the belt housings, a foolproof bore is visible on the upper portion for possible stacking between cases, as well as four housings for such stacking;

FIGS. 5 to 14 show the main components of the case shown in FIG. 1 in an exploded perspective, from bottom to top:

FIG. 5 shows the back visible on FIG. 2, with its columns and their lower locking nuts;

FIG. 6 shows a frame which, on its upper portion, supports ten soles made of a flexible resilient material for backlash compensation, trampled on by plastic clips, and on each of which a particular measuring support is suspended. The lower portion supports an electronic module, which carries the energy storage means via a battery holder, and which is wired to internal sensors arranged beneath the measuring supports;

FIG. 7 shows a lower resilient element which has a wedging plate for holding, back wedging and orientation of each watch head, and which can be plugged onto the soles made of a resilient material by means of legs;

FIG. 8 shows the belt of FIG. 3, with one of the chambers housing and tightening the second lateral resilient element and everything it encloses;

FIG. 9 shows two rows of a first lateral resilient element arranged to hold and dampen the crystal and back of the watch head;

FIG. 10 shows the second lateral resilient element enclosing the first lateral resilient elements;

FIG. 11 shows the watch heads;

FIG. 12 shows two upper resilient elements, each arranged to press a row of five watch heads into the closure and locking position;

FIG. 13 shows the two locking drawers visible in FIGS. 1 and 4, with their eye grooves arranged to cooperate with the column grooves on the back;

FIG. 14 shows the cover shown in FIG. 4;

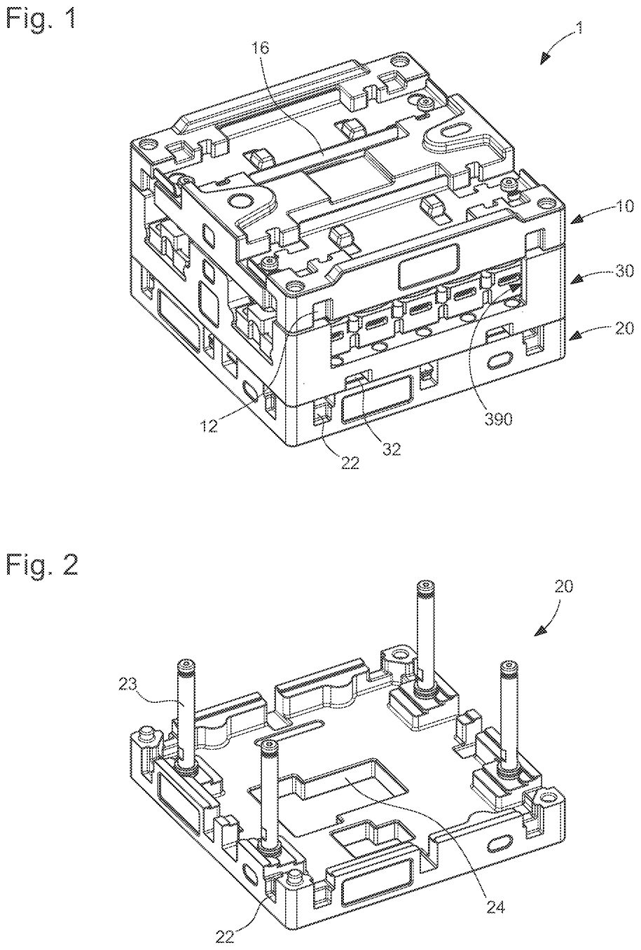

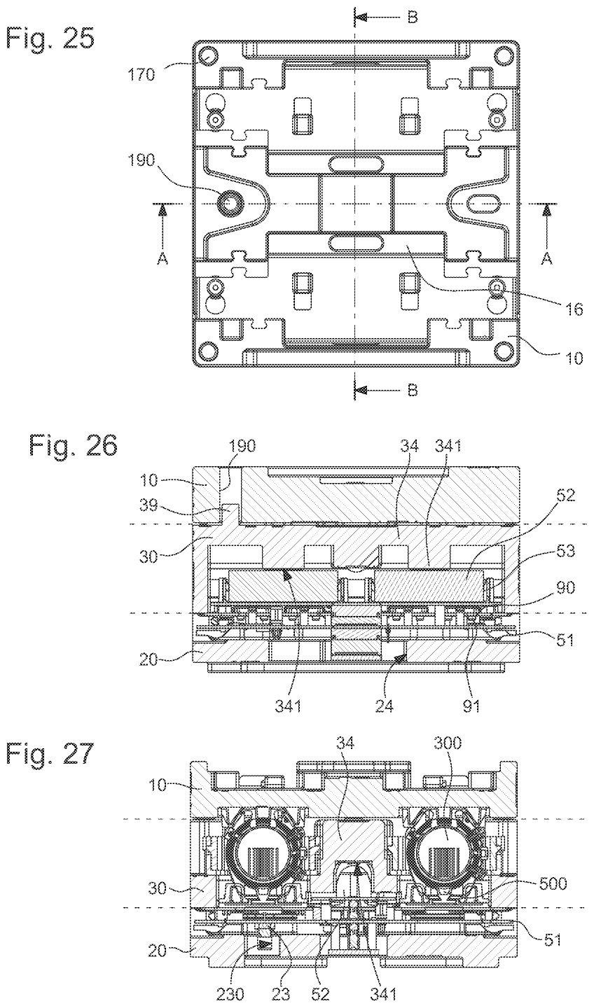

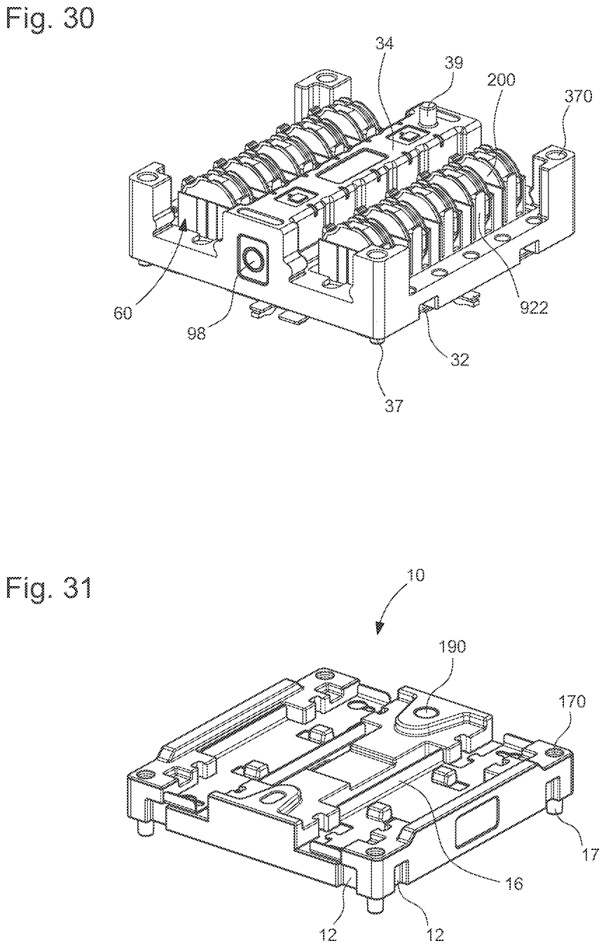

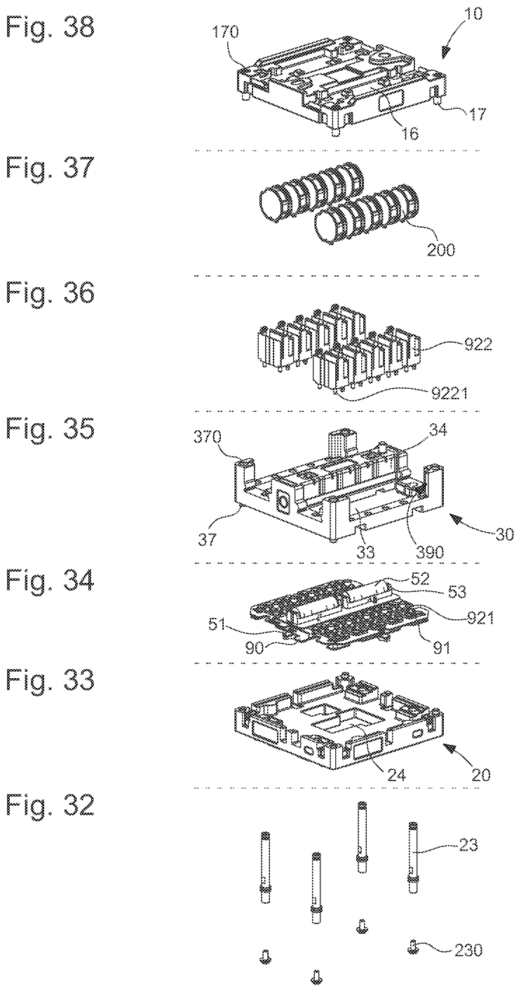

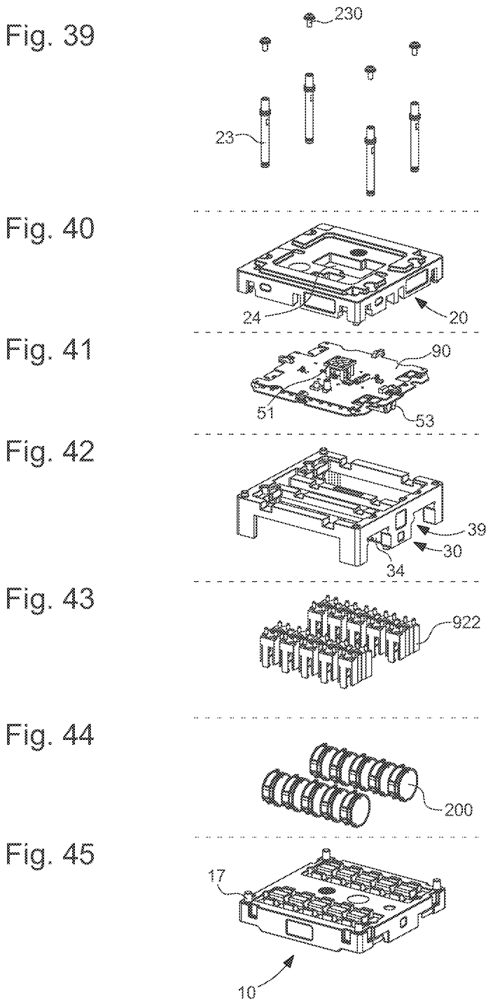

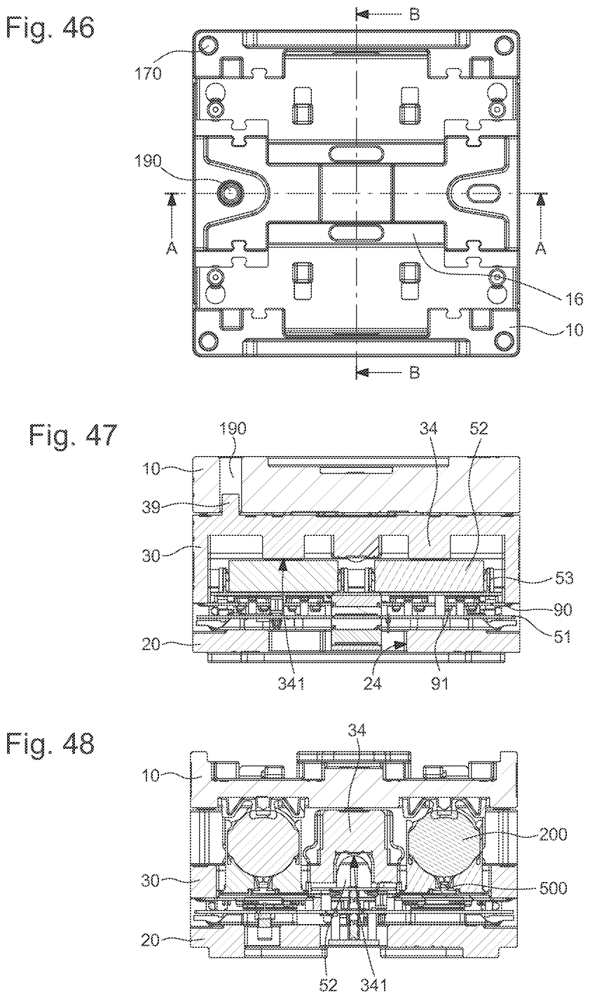

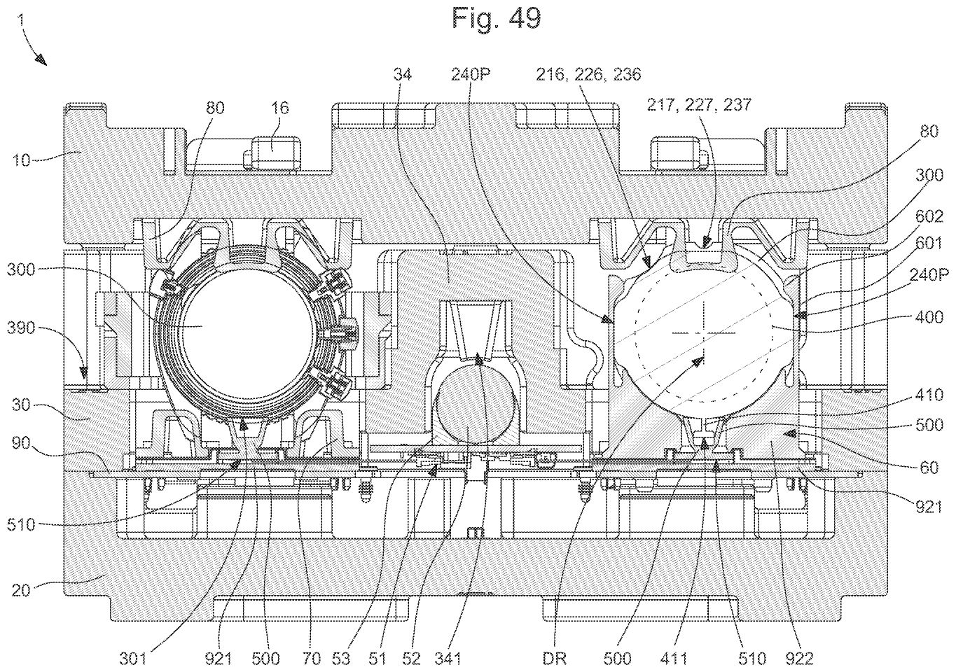

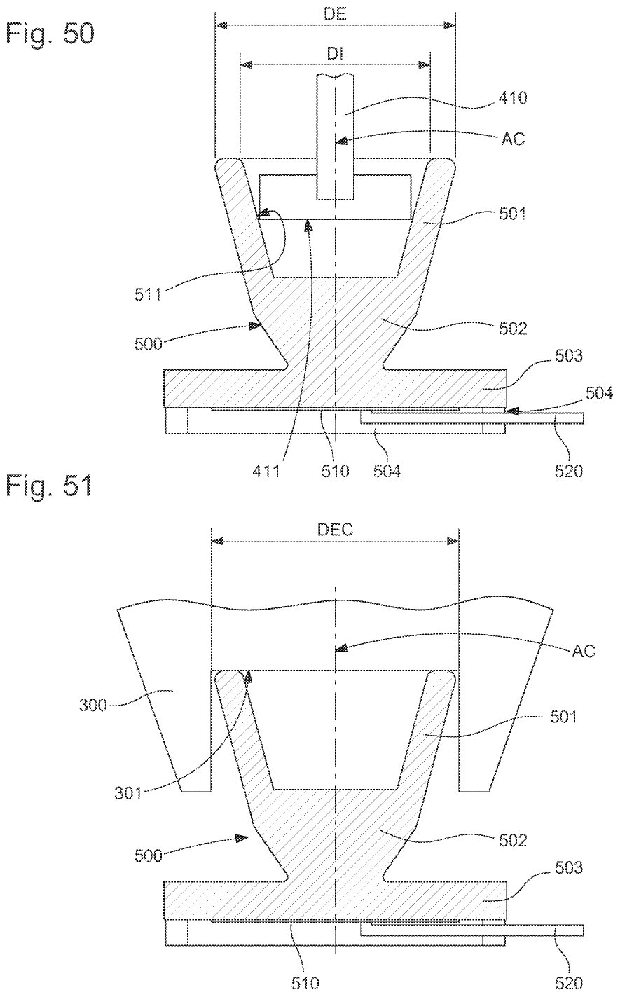

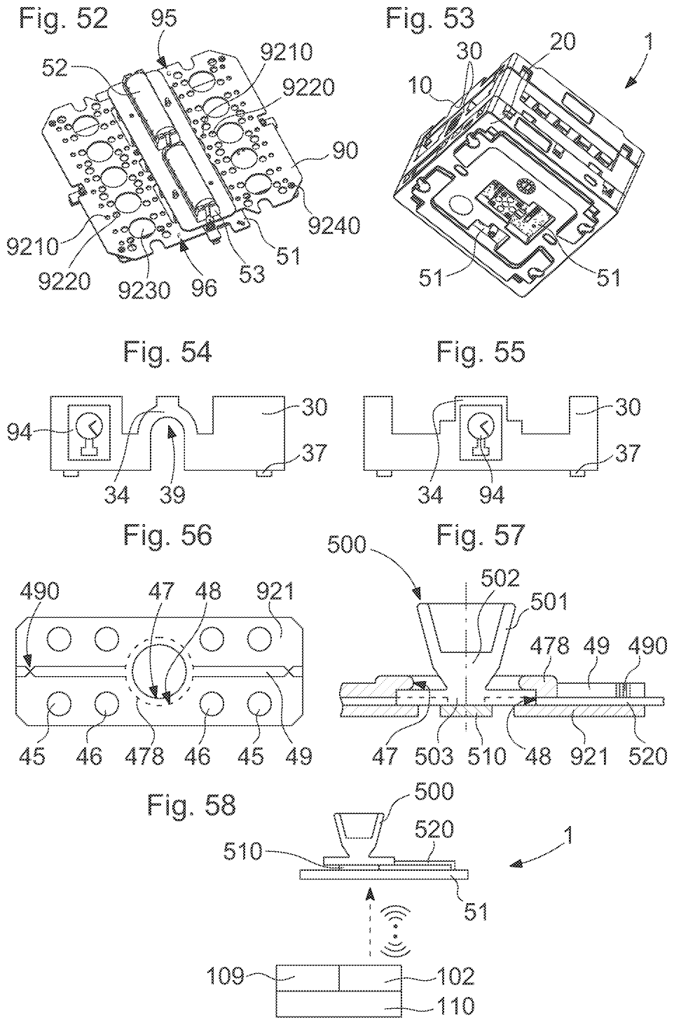

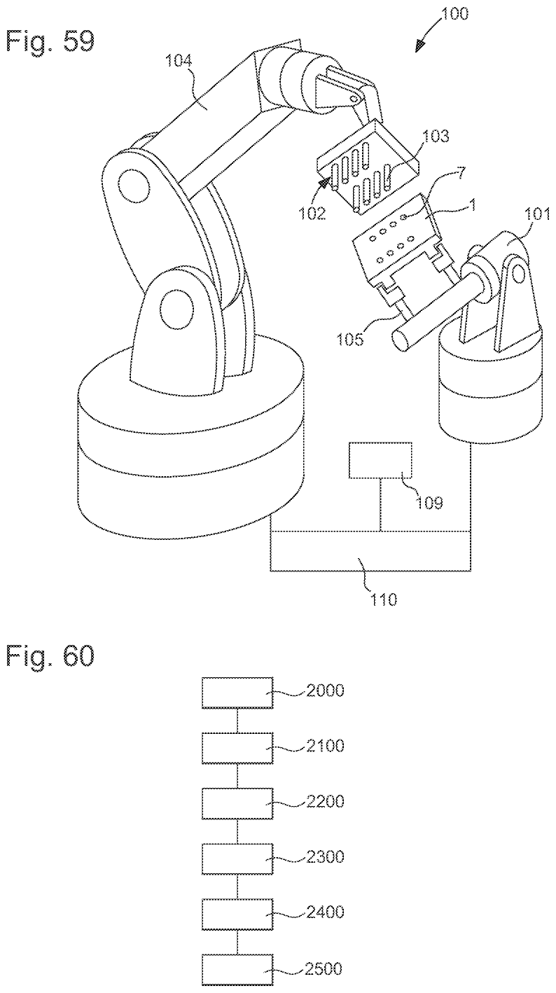

FIGS. 15 to 24 show, in an exploded perspective, from top to bottom, the components of the case shown in FIG. 1, in an inverted view with respect to FIGS. 5 to 14:
FIG. 15 shows the back;
FIG. 16 shows the frame and the electronic module;
FIG. 17 shows the lower resilient element;
FIG. 18 shows the belt, with the batteries bearing on the protective cover;
FIG. 19 shows the two rows of the first lateral resilient element;
FIG. 20 shows the second lateral resilient element;
FIG. 21 shows the watch heads;
FIG. 22 shows the two upper resilient elements;
FIG. 23 shows the two locking drawers with their eye grooves;
FIG. 24 shows the cover;

FIG. 25 shows a schematic top view of the cover of the case shown in FIG. 1;

FIG. 26 shows a schematic section of the case shown in FIG. 1, using the plane AA in FIG. 25;

FIG. 27 shows a schematic section of the case shown in FIG. 1, using the plane BB in FIG. 25;

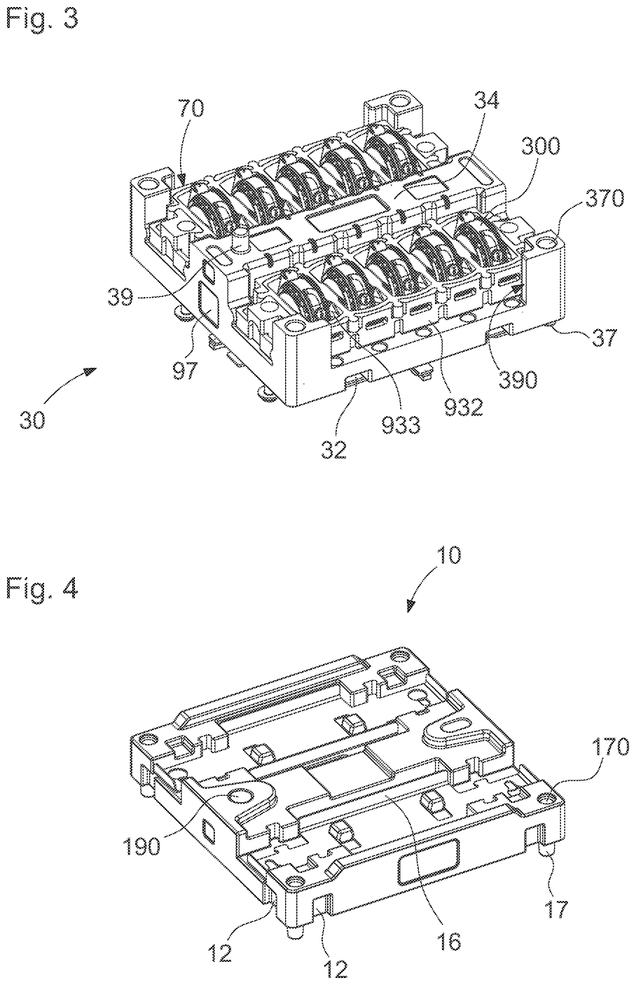

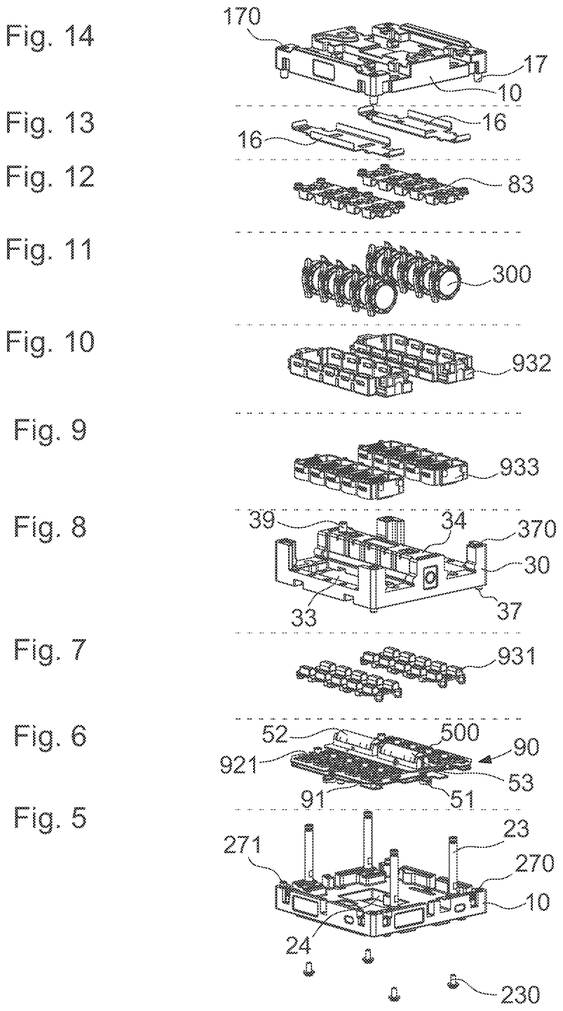

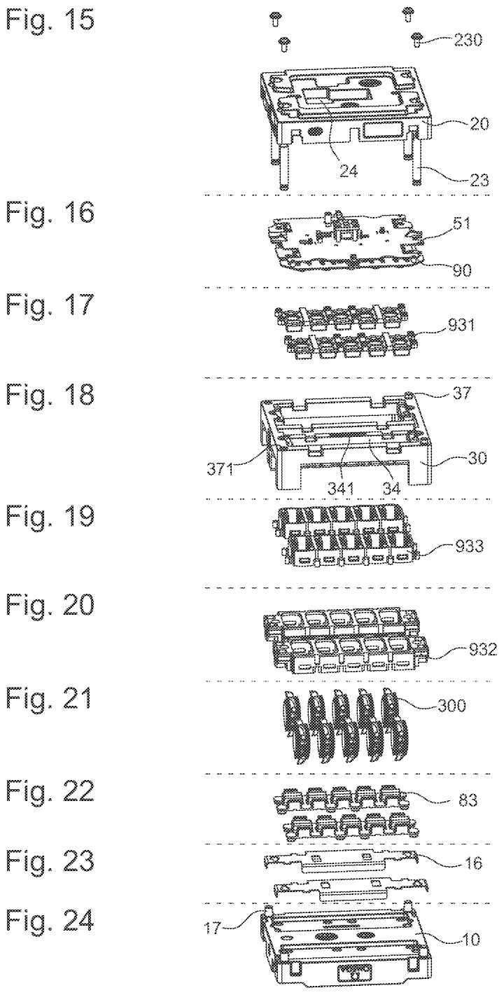

FIGS. 28 to 31 illustrate, in a similar way to FIGS. 1 to 4, a further variant of the case, each containing a movement:
FIG. 28 shows a schematic perspective view of the complete case containing the calottes;
FIG. 29 shows the back of the case shown in FIG. 28;
FIG. 30 shows the belt of the case shown in FIG. 28, with the calottes each held in place by a clamp-like nest, inserted by legs into the sole made of a resilient material;
FIG. 31 shows the cover of the case shown in FIG. 28;

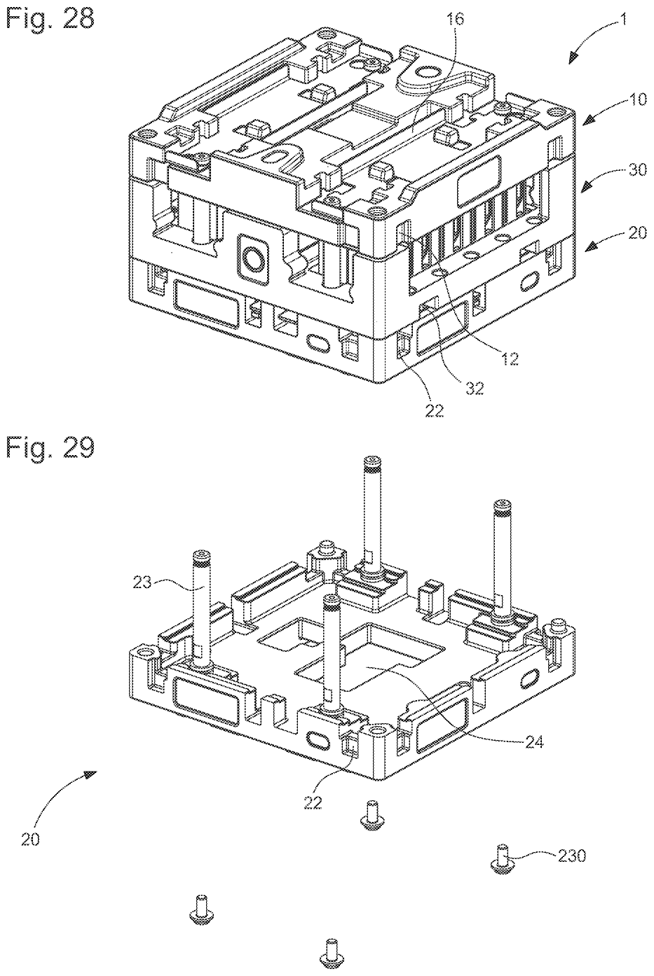

FIGS. 32 to 38 show the main components of the case shown in FIG. 28 in an exploded perspective, from bottom to top:
FIG. 32 shows the back columns and their lower locking nuts;
FIG. 33 shows the back visible on FIG. 29;
FIG. 34 shows a frame similar to FIG. 6;
FIG. 35 shows the belt shown in FIG. 30;
FIG. 36 shows two rows of plug-in nests forming clamps for orienting and clamping the calottes;
FIG. 37 shows the calottes;
FIG. 38 shows the cover shown in FIG. 31;

FIGS. 39 to 45 show, in exploded perspective, from top to bottom, the components of the case shown in FIG. 28, in an inverted view with respect to FIGS. 32 to 38:
FIG. 39 shows the back columns and their lower locking nuts;
FIG. 40 shows the back;
FIG. 41 shows the frame;
FIG. 42 shows the belt;
FIG. 43 shows the plug-in nests;
FIG. 44 shows the calottes;
FIG. 45 shows the cover;

FIG. 46 shows a schematic top view of the cover of the case shown in FIG. 28;

FIG. 47 shows a schematic section of the case shown in FIG. 28, using the plane AA in FIG. 46;

FIG. 48 shows a schematic section of the case shown in FIG. 28, using the plane BB in FIG. 46;

FIG. 49 shows a schematic representation, in section through the plane BB of FIGS. 27 and 46, of a particular variant representing the case of FIG. 1 containing watch heads on the left-hand side, and the case of FIG. 28 containing calottes on the right-hand side;

FIG. 50 shows a schematic representation of a measuring support, in section through an axis of revolution, comprising an inverted bell-shaped horn, the widest side of which is turned towards the object to be measured, in this case a dome containing a movement, the end crown of the test rod of which is in contact with the inner portion of this horn, which in this particular, non-limiting embodiment is substantially conical. This bell guides the vibrations to a more solid portion, which acts as a concentrator integral with a back under which a sensor is held, here a piezo sensor in this particular example. This back has a slot to accommodate the cable linking the sensor to an electronic module;

FIG. 51 shows a schematic section through an axis of revolution of the measuring support, which herein rests on a measuring area of an edge of a watch head, more specifically between two adjacent horns of this watch head;

FIG. 52 shows a schematic perspective view of a frame arranged to receive the sole made of a resilient material and various lower resilient elements. This frame comprises, symmetrically around a median portion occupied by batteries, mounted in a battery holder integral with an electronic module visible below the frame, two rows of five hole arrays each comprising, around a central orifice, an outer group of four holes to receive clips for trapping a sole made of a resilient material, and an inner group of four holes to receive legs of lower resilient elements, in particular nests in the case of calottes. The frame advantageously comprises diametrically opposed markings, one to show the position of the “back” side of the horological movements, the other to show the position of the “dial” side of these movements; the frame advantageously comprises mechanical foolproofs to align these back and dial sides with corresponding markings on the case back and/or belt;

FIG. 53 shows a schematic perspective view of an assembled case from below, with a window in the back providing access to at least one electronic module in the case;

FIG. 54 shows, in schematic form and in side view, a belt variant with a passage under the battery protection cover, and a recessed marking indicating the dial side of the calottes for which this belt is made;

FIG. 55 shows, in schematic form and in side view, another variant of a completely solid belt under the battery protection cover, and a similar recessed marking indicating the dial side of calottes for which this belt is made;

FIG. 56 shows, in schematic form and in planar view, a sole made of a resilient material comprising a network of holes with, around a central orifice, an outer group of four holes to receive trapping clips on the frame of FIG. 52, and an inner group of four holes to receive legs of lower resilient elements, in particular nests in the case of calottes; the central hole is bordered by a bead covering a groove for receiving the back of a measuring support as per FIG. 50 or 51, and the element made of a resilient material comprises a groove for cable passage and a constriction 490 acting as a clamp for immobilising this cable;

FIG. 57 shows a schematic section through the axis of revolution of a measuring support as shown in FIG. 50 or 51, with this measuring support, equipped with an internal piezo sensor on its lower portion, clipped into the groove of the sole made of a resilient material shown in FIG. 56; the piezo sensor connection cable is housed and clamped in the groove of the sole made of a resilient material;

FIG. 58 shows, in schematic form, a wireless link, for example infrared, between the piezo sensor of FIG. 57, and means external to the case, and included in the device according to the invention, for example herein detection means arranged to collect information from the internal piezo sensor or from an electronic module 51, and an external sensor, associated with a centralised testing system included in the device;

FIG. 59 shows a schematic perspective view of a device according to the invention, comprising such cases and their accessories, in particular calottes, and including on the one hand means for handling these cases, and on the other hand fixed or mobile heads comprising sensors or adjustment tools;

FIG. 60 is a block diagram of the main stages of a horological movement test and/or adjustment method implemented with such cases and with this device.

### DETAILED DESCRIPTION OF THE INVENTION

The invention relates to a device 100 for testing a timepiece, comprising at least one case 1 arranged to receive calottes 200 and/or watch heads 300. FIGS. 1 to 58 illustrate different variants of such cases 1, and some of their particular components.

Each calotte 200 houses a horological movement 400, with a control member 410, such as a winding and/or time-setting stem, projecting from the calotte 200 in a radial direction DR.

Each watch head 300 houses such a horological movement 400.

Each case 1 comprises at least one removable and stackable back 20, a frame 90 comprising at least one measuring support 500 arranged to form a lower support for a calotte 200 or watch head 300, and an upper portion.

The frame 90 comprises at least one innovative measuring support 500, which will be detailed later, and which is arranged to constitute a lower support for such a calotte 200 or watch head 300, in a measuring position.

This upper portion comprises at least one cover 10, which is provided with at least one locking element 16, in particular a drawer, which is arranged to cooperate in a complementary manner with a locking structure 23 which the back 20 comprises in a position for closing and locking the case 1. In this closure and locking position, at least one upper resilient element 80, 83, which is interposed between the frame 90 and the cover 10, or which is carried by the cover 10, is compressed by locking of a locking element 16, to hold each calotte 200 and/or each watch head 300 enclosed by the case 1. In the non-limiting example illustrated by the figures, the locking element 16 is a drawer sliding in grooves in the cover 10, and which has eye grooves, which cooperate with the end grooves of two columns 23 fixed to the back 20, in particular by means of a nut 230 or the same. A clip stop maintains the end-of-travel locking position of these drawers.

According to the invention, each measuring support 500 is supported by a sole made of a flexible resilient material enabling backlash compensation 921, and is without direct contact with the frame 90 or with the back 10. This measuring support 500 is arranged to carry at least one internal sensor 510 arranged to listen to the running of a horological movement 400 enclosed in a calotte 200 or watch head 300, in this closure and locking position, where the distal end 411 of the control member 410 in the case of a calotte 200, or respectively a support area 301, for example between the lugs 300, of a watch head 300, is in support on the measuring support 500, on an edge of this control member 410 or respectively of the watch head 300. And each horological movement 400 contained in the case 1 is acoustically isolated from the other horological movements 400 contained in the case 1 by other resilient elements 60, 70, 80, 922, 931, 932, 933 contained in the case 1.

More particularly, some resilient elements 60, 70, 80, 922, 932, 933, constitute or comprise receptacles arranged to surround a calotte 200 or watch head 300, separating it from neighbouring calottes 200 or watch heads 300, at least at the level of the back and dial sides of the horological movement 400 enclosed by the calotte 200 or watch head 300.

More particularly, some resilient elements 922, 931, 933, are arranged to angularly position a calotte 200 or watch head 300 relative to a measuring support 500, in a plane perpendicular to a main plane defined by the frame 90. In this way, the radial direction DR of a calotte 200 is positioned perpendicular to this main plane. In the same way, the support area 301 chosen for measuring the watch head 300 is positioned in the correct orientation, as shown in FIG. 49, which illustrates the two cases: the watch head 300 on the left, and the calotte 200 on the right.

In particular, some resilient elements 932, 933, 80, 83, are arranged to cover other resilient elements 922, 931, 933, 932, to grip each calotte 200 or each watch head 300 as tightly as possible in the closure and locking position.

More specifically, at least one resilient element, or more particularly each resilient element 60, 70, 80, 921, 922, 931, 932, 933, 80, 83, in the case 1 is made of a flexible resilient material enabling backlash compensation, or comprises such a resilient material on each side intended to be in contact with a calotte 200 or a watch head 300. The flexibility of such a resilient element is essentially related to its shape, and these elements perform two major functions: insulation and backlash compensation (in the range of one millimetre). Some resilient elements acting as clamps, such as nests 922 arranged to receive the calottes, have a plastic structure, comprising resilient elements acting as clamps, injected to facilitate the manufacture of the clamp arms 601 they comprise. This structure is advantageously lined internally with a flexible resilient material enabling backlash compensation. The same type of manufacture can be used for other resilient elements of the case, such as a first lateral resilient element 933 or a second lateral resilient element 932, described later on.

More particularly, and as in all the variants illustrated in the figures, the upper portion comprises at least one removable belt 30, which is arranged to be stacked between the back 20 and the cover 10. This belt 30 comprises at least one through chamber 33, which is arranged to directly or indirectly surround a plurality of calottes 200 or watch heads 300 insulated from the walls of chamber 33 by at least one resilient element 922, 931, 932, 933.

In particular, the locking structure on the back 20 comprises columns 23, which pass through at least one electronic module 51 arranged to be placed on the back 20. The electronic module 51 is hidden by the frame 90 to prevent any contact between its components and energy storage means 52, in particular batteries or the like, arranged on the opposite side. And this back 20 comprises at least one window 24, which is arranged for the connection of external circuits for data exchange with at least one such electronic module 51, and for the connection of external circuits for powering these energy storage means 52, which are protected by the frame 90. The battery holder 53 may comprise a rigid structure, clipped onto the frame 90. The electronic module 51 has markings identifying the back and dial sides of the movements 400.

More particularly, the belt 30 comprises at least one cover 34 for insulating and protecting these energy storage means 52, fixed in a compartment 53, in particular a battery holder, carried by the frame 90 or by at least one electronic module 51. Advantageously, this cover 34 comprises an internal stop 341, in particular resilient, facing the energy storage means 52.

More particularly, the sole made of a resilient material 921 comprises, around a central orifice 47, a network of first holes 45, which are arranged to receive fastening means, in particular and not exclusively elastic clips 91 arranged to cooperate with a network of fastening holes 9210 in the frame 90, these elastic clips 91 are preferably made of plastic. The sole made of a resilient material 921 also comprises a network of second holes 46, which face passages 9220 in the frame 90, these second holes 46 being arranged to receive legs 9221 in some of the resilient elements 60, 70, 80, 922, 931, 932, 933. A clot 478 surrounds the central hole 47, and has an internal groove 48 for housing a base 503 of a measuring support 500. In this way, each measuring support 500 is suspended and electrically isolated from the frame 90 and the structure of the case 1, as are the movements 400, the calottes 200 and the watch heads 300.

In particular, as can be seen in the variant shown in FIGS. 28 to 48, the device 100 comprises universal calottes 200 adapted to all the cases 1 in the device 100: the calottes 200 are all externally identical for a given device 100; the cases 1, in turn, can receive equipment as required, in particular resilient elements adapted to the objects to be tested: calottes 200 or watch heads 300. FIG. 49 shows a theoretical case study in which one chamber 33 receives watch heads, and the other receives calottes 200, which is what the configuration of the cases 1 according to the invention allows, even though this is not the best solution in terms of logistics, as it is easier to manage cases 1 each with uniform contents.

While the calottes 200 are all identical for a given device 100, they differ internally according to the nature of the movement 400 intended to be inserted therein, and each model is adapted to project the distal portion 411 of the control member 410 with respect to a reference axis common to all calottes 200: with respect to the outer profile and a single reference, the dimension of bearing on a support 500 is identical for all calottes 200 even when containing movements 400 different from one another. More particularly, the calotte 200 includes planar external plates 218, 238, respectively forming a back 210 and a cover 230, which delimit it, and which frame bearing surfaces 219, respectively 239, of the back 210 and of the cover 230; these bearing surfaces 219 and 239 rest flush on a transport ring 220 which carries the movement 400 and determines its orientation, the radial direction DR, and the eccentricity of the distal portion 411 of the control member 410 relative to a reference axis common to all calottes 200, the eccentricity being identical for all calottes 200 and all movements 400. The edges of these planar external plates 218, 238, preferably include planar reference surfaces 240P, which define the reference axis DC with respect to which the eccentricity of the crown is determined. The back 210, the cover 230 and the transport ring 220 include an indexing relief 217, 237, 227, such as a notch or the same. Preferably, they also include an orientation relief 216, 236, 226, allowing determining, in relation to the indexing relief, the location of the dial side and back side of the movement 400.

More particularly, to receive each calotte 200, case 1 comprises a lower receptacle 60, which is more particularly a resilient nest 922 pluggable by legs 9220 onto a sole made of a resilient material 921, and which internally comprises female indentations corresponding to a portion of the external contour of planar external plates 218, 238, of the calotte 200, with supports arranged to cooperate with planar reference surfaces 240P of the calotte 200. Advantageously, the nests 922 comprise resilient blades 601, with an end clot or lip 602, which are arranged to keep a calotte 200 trapped in abutment on a measuring support 500 at the distal end 411 of a control member 410 of a movement 400 enclosed in the calotte 200, in a measurement position in which the radial direction DR of the control member 410 is aligned with the measuring support 500. The nests 922 may be single, as shown in the figures, or multiple, the single configuration facilitates plugging onto the sole made of a resilient material 921.

More particularly, as can be seen in the variant shown in FIGS. 1 to 27, the case 1 is arranged to receive watch heads 300, and comprises, for the reception of each watch head 300, at least one lower resilient element 70 which comprises a wedging plate 931 arranged for holding, back wedging and orientation of the watch head 300 and which can be plugged by means of legs onto a sole made of a resilient material 921, a first lateral resilient element 933 arranged to hold and dampen the crystal and the back of the watch head 300, and a second lateral resilient element 932 arranged to fit in a chamber 33 and compress the first lateral resilient element 933 around each watch head 300.

More particularly, the case 1 comprises, for housing thereof in each chamber 33, such a second lateral resilient element 932 which comprises several hollow profiles, a first lateral resilient element 933 comprising the same number of receptacles, and a wedging plate 931 with the same number of wedging cells, and also comprises an upper resilient element 80, 83, with the same number of supports. The figures illustrate an example with rows arranged to receive five watch heads 300.

More particularly, each wedging plate 931 and at least each first lateral resilient element 933 are arranged to orientate a bearing surface 301 of a watch head 300, in particular located between two horns of the watch head 300 in the non-limiting example of FIG. 49, to cooperate while bearing with a measuring support 500.

In particular, at least the frame 90 includes identification markings on the dial side 95 (mark C) or on the back side 96 (mark F) of the calottes 200 or watch heads 300.

More particularly, the case 1 includes mechanical foolproofs to ensure uniform positioning of the dial side and back side of the calottes 200 or watch heads 300. Advantageously, the case 1 includes pictograms or recessed mouldings 94, 97, 98 on some of its constituent elements, enabling the user to easily distinguish: use for calottes 200 or for watch heads 300, dial side and back side, position of the crown or other elements of the movements 400.

The device 100 according to the invention advantageously comprises measuring supports 500 which are arranged to channel the vibratory signal emitted by a movement 400 towards an acoustic sensor 510. More particularly, as shown in FIGS. 49, 50, 51, 57, 58, each support 500 comprises a bell 501, preferably axisymmetric, and similar to a bell with a conical or evolving inner profile, narrowing towards a solid area 502 forming a concentrator arranged above a base 503 receiving the sensor 510. On its widest open side, this pavilion has an external diameter DE, smaller than the interspace between horns of the watch cases 300 to be processed in the case 1, and an internal diameter DI larger than the diameter of the crowns of the movements 400 enclosed in the calottes 200 to be processed by the case 1, these crowns coming into contact with the internal bearing surface 511 of the bell 501. A groove 504 allows the passage of a cable 520 or the same connected to at least one electronic module 51. The base 503 is advantageously housed in a groove 48 provided by a sole made of a resilient material 921, and wedged by a clot 478 which ensures holding thereof. This same sole 921 also includes a groove 49 for the passage of the cable 920, and advantageously a narrowing 490 acting as a clamp to immobilise this cable 520.

More particularly, each internal sensor 510 is a piezo sensor, and each electronic module 51 is arranged to emit and/or receive infrared and/or other signals for triggering manipulation means 101 for moving at least one case and arming automatic winding mechanisms included in the horological movements 400 contained in the case 1. Preferably, test means 110 external to the case 1 thus activate the electronic module 51 of the case, which sends back its information.

More particularly, these manipulation means 101 comprise at least one manipulator, which is arranged to manipulate, in particular by means of at least one gripper 105, at least one such case 1, included in this device 100. Such a manipulator 101 or gripper 105 is arranged to cooperate with gripping means 12, 22, 32, included in each case 1.

As shown in FIG. 58, the device 100 advantageously comprises detection means 109, which are arranged to collect information from the internal sensor 510 and/or at least one electronic module 51, and drive each manipulator 101 accordingly.

More particularly, the manipulator 101 comprises at least one external sensor 102 and/or tool 103, which is arranged to be inserted through openings in a case 1, and which is arranged to perform a measurement and/or adjustment on a timepiece 400 housed in a compartment of the case 1.

More particularly, an external sensor 102 is a microphone, or a camera, or a contact vibration sensor.

More particularly, a tool 103 is a mechanical, magnetic or other tool.

More particularly, the manipulator 101 comprises as many external sensors 102 and/or tools 103 as a case 1 comprises compartments. In particular, the manipulator 101 is a multi-axis robot, capable of simulating any position in space, and not just the usual chronometric test positions, but any realistic position in space. According to the arrangement, the same manipulator 101, or advantageously another related manipulator 104, comprises an end arm which includes a head fitted with these various external sensors 102 or tools 103, to enable simultaneous intervention on all timepieces 1000 that a particular case 1 comprises. Such a manipulator 101 or 104 can thus, depending on the test to be carried out, implement a head equipped with external sensors 102, or a head equipped with tooling 103, or a mixed head equipped with both external sensors 102 and tooling 103, or others.

More specifically, the manipulator 101 is arranged to handle each case 1 at least in different test and/or chronometric adjustment positions, under different physical conditions: at different temperatures, at different humidity levels, under different pressures or depressions, or subjected to vibrations, or gaseous or liquid flows, or others. Of course, these operations can be carried out not only in particular positions, but also during programmed movements between different positions in space.

The device 100, or the manipulator 101 it comprises, includes test means 110, which are arranged to manage its movements in space, as well as the duration of tests and/or adjustments in the different positions occupied by each case 1, and/or during the different movements imparted to this case 1. Of course, the manipulator 101 can also be arranged to manipulate several 1 cases at the same time.

More particularly, the device 100 includes manoeuvring means arranged to open and close the covers 10 relative to the backs 20, to perform magnetic field test operations, and/or pressure/vacuum test operations, and/or tightness test operations, and/or etching operations, and/or washing operations, or others. These manoeuvring means may be manipulators 101 or 104, or other automated manipulation means. They cooperate with notches or lugs 12, 22, 32 in the cover 20, back 10 and belt 30 respectively.

The device 100 advantageously comprises means for reading identification elements on the cases 1, and means for detecting the position in space of indexing elements also on the cases 1. The manipulator 101 thus has all the information relating to the cases 1, their position and their contents, and the test means 110 are preferably intended to be interfaced with production management means to ensure traceability of the cases 1 and their contents.

The invention further relates to a method for testing and/or adjusting a horological movement 400 with such a device 100, according to which:
(2000) said movement 400 is inserted into a suitable calotte 200, or assembled within a watch head 300;
(2100) a case 1 is provided which is equipped with lower resilient elements adapted, as the case may be, to receive calottes 200, or watch heads 300 of a given model, and suitable upper resilient element(s) 80, 83;
(2200) each calotte 200, or respectively each watch head 300, is deposited in a compartment of the case 1, and surrounded by the appropriate resilient elements;
(2300) the cover 10 of the case 1 is closed by compressing the resilient elements, and each calotte 200, or respectively each watch head 300, bearing on a measuring support 500, is pressed on an edge of the calotte 200 or respectively of the watch head 300;
(2400) the recommended measurement cycles are performed, and the case 1 is manipulated in different positions in space;
(2500) for each of these positions, at least one test and/or adjustment operation of the horological movement 400 is carried out by means of an external sensor 102 communicating with an internal sensor 510 via a printed circuit 51, and/or by means of a tool 103.

More particularly, the case 1 is manipulated in various positions for chronometric test and/or adjustment, and in each position the horological movement 400 is tested and/or adjusted.

More particularly, the horological movement 400 is equipped with internal adjustment means adapted to cooperate with non-intrusive external adjustment means, in particular using a laser to modify the mechanical parameters of an oscillator included in this horological movement 400.

Still more particularly, a plurality of horological movements 400, each enclosed in a compartment of the same case 1, are tested and/or adjusted simultaneously.

The invention allows providing universal cases for processing calottes or watch heads. Indeed, the cases may comprise standardised elements: back, frame, cover. The belts can be differentiated according to the operations to be performed on the calottes or watch heads; as the case may be, they can comprise lateral openings 390, which can be easily sealed, or else be completely closed on the sides. Lateral sealing is useful for isolating a case from neighbouring cases, as the activation of a given case by an infrared signal must not also trigger the activation of neighbouring cases, which is undesirable. On the other hand, a variant with a lateral opening allows the insertion of a tool such as pliers or the like. These structural elements can be made of injection-moulded plastic, or even hard plastic foam such as expanded polypropylene, or the same.

The structural elements include notches or lugs 12, 22, 32, for gripping thereof, they also include legs 17, 271, 37, and housings 170, 270, 370, 371, both for internal stacking within a case, and for stacking between the cases. Some of these legs are foolproof studs 39, cooperating with foolproof housings 190, guaranteeing the proper orientation of the components. The number of notches, lugs and legs on each face can also be different, ensuring effective foolproofing. These legs also allow protecting the resilient elements from dust, particularly the upper resilient elements often fixed under the covers, when the considered structural elements are placed on a work surface. The watch positions are marked on the cases and their structural elements.

The resilient elements are standardised for the treatment of calottes, which are all externally identical, and enable the end of the crown to be presented at a perfectly known fixed dimension. The resilient elements for the watch heads can be adapted in different sizes, but with a small number of different models, which facilitates storage and distribution logistics.

In the case of both calottes and watch heads, the cases offer a unique internal geometric reference system, the positions of the measuring supports are fixed, and the internal arrangement of the cases allows guaranteeing perfect orientation and position of the calottes and watch heads. Naturally, this internal geometrical reference system depends on the shape of the frames, which can be easily modified, as they can be made very economically from stamped sheet metal.

These cases can easily be used for testing in the standardised positions required by testing bodies and the manufacturer's internal rules. The use of markings on the outside of the cases, by barcode or the same, allows distinguishing the back and dial sides of the movements, and the 3 o'clock and 9 o'clock positions.

The use of the soles made of a flexible resilient material to compensate for backlash allows vibration to be damped and limits neighbouring disturbances between the movements contained in the case; it also guarantees electrical isolation. In particular, all piezo sensors are isolated from each other, which is essential for quality measurement.

In addition to the advantage of a quality measurement that is much more reliable than probing on a watch crystal or case back, the particular measuring support implemented by the invention offers appreciable versatility, since it is suitable for both calottes and watch heads; in the latter case, the support between the horns is advantageous, and allows not touching the external surfaces of the watch head.

1. A device for testing a timepiece, comprising at least one case arranged to receive calottes and/or watch heads, each said calotte enclosing a horological movement, a control member of which projects from said calotte, each said watch head enclosing such a horological movement, each said case comprising at least one removable and stackable back, a frame comprising at least one measuring support arranged to constitute a lower support said for said calotte or said watch head, and an upper portion comprising at least one cover provided with at least one locking element arranged to cooperate in a complementary manner with a locking structure which said back comprises in a closure and locking position of said case in which closure and locking position at least one upper resilient element interposed between said frame and said cover is compressed to hold each said calotte and/or each said watch head enclosed by said case, wherein each said measuring support is supported by a sole made of a flexible resilient material enabling backlash compensation and is without direct contact neither with said frame nor with said cover and is arranged to carry at least one internal sensor arranged to listen to the running of said horological movement enclosed in said calotte or said watch head in said closure and locking position where said control member or respectively said watch head bears on said measuring support, on an edge of said control member or respectively of said watch head, and wherein each said horological movement contained in said case is phonically isolated from the other said horological movements included in said case by other resilient elements contained in said case.

2. The device for testing and/or adjusting a timepiece according to claim 1, wherein some of said resilient elements constitute or comprise receptacles arranged to surround said calotte or said watch head, separating it from said calottes or said watch heads adjacent thereto, at least at the level of the back side and the dial side of said horological movement enclosed by said calotte or said watch head.

3. The device for testing and/or adjusting a timepiece according to claim 1, wherein some of said resilient elements are arranged to angularly position said calotte or said watch head with respect to said measuring support, in a plane perpendicular to a main plane defined by said frame.

4. The device for testing and/or adjusting a timepiece according to claim 1, wherein some of said resilient elements are arranged to cover other of said resilient elements to grip each said calotte or each said watch head as tightly as possible in said closure and locking position.

5. The device for testing and/or adjusting a timepiece according to claim 1, wherein each said resilient element included in said case is made of a flexible resilient material enabling backlash compensation, or includes resilient material on each side intended to be in contact with said calotte or said watch head.

6. The device for testing and/or adjusting a timepiece according to claim 1, wherein said upper portion comprises at least one belt removable and arranged to be stacked between said back and said cover, said belt comprising at least one chamber arranged to directly or indirectly surround a plurality of said calottes or said watch heads isolated from the walls of said chamber by at least one said resilient element.

7. The device for testing and/or adjusting a timepiece according to claim 1, wherein said locking structure included in said back comprises columns which pass through at least one electronic module arranged to be fixed to said back, and wherein said back comprises at least one window arranged for the connection of external circuits for exchanging data with said at least one electronic module, and for the connection of external circuits for supplying energy storage means included in said at least one electronic module.

8. The device for testing and/or adjusting a timepiece according to claim 6, wherein said at least one belt comprises at least one cover for insulating and protecting said energy storage means fixed in a compartment carried by said frame or by at least one said electronic module.

9. The device for testing and/or adjusting a timepiece according to claim 1, wherein said sole made of a resilient material comprises a network of first holes arranged to receive elastic clips arranged to cooperate with a network of fixing holes included in said frame, and a network of second holes facing passages included in said frame, said second holes being arranged to receive legs included in some of said resilient elements.

10. The device for testing and/or adjusting a timepiece according to claim 1, wherein said device includes said calottes adapted to all said cases included in said device, and wherein, for the reception of each said calotte, said case comprises said lower receptacle which is a resilient nest pluggable onto said sole made of a resilient material and internally comprising female indentations corresponding to a portion of the external contour of planar external plates delimiting said calotte, with supports arranged to cooperate with planar reference surfaces on the edges of said planar external plates, said nests comprising resilient beak-shaped blades arranged to keep said calotte trapped in abutment on said measuring support at the distal end of said control member of said movement enclosed in said calotte, in a measuring position in which a radial direction (DR) of said control member is aligned with said measuring support.

11. The device for testing and/or adjusting a timepiece according to claim 6, wherein, for receiving each said watch head, said device comprises at least one lower resilient element which comprises a wedging plate arranged for holding, back wedging and orientation of said watch head, a first lateral resilient element arranged to hold and dampen the crystal and the back of said watch head, and a second lateral resilient element arranged to be housed in said chamber and compress said first lateral resilient element.

12. The device for testing and/or adjusting a timepiece according to claim 11, wherein said device comprises, for housing thereof in each said chamber, said second lateral resilient element which comprises a plurality of hollow profiles, said first lateral resilient element comprising the same number of receptacles, and said wedging plate with the same number of wedge cells, and further comprises said upper resilient element with the same number of supports.

13. The device for testing and/or adjusting a timepiece according to claim 11, wherein each said wedging plate and at least each said first lateral resilient element are arranged to orient a bearing surface of said watch head, located between two horns of said watch head, to cooperate while bearing with said measuring support.

14. The device for testing and/or adjusting a timepiece according to claim 1, wherein at least said frame comprises identification markings on the dial side or the back side of said calottes or said watch heads, and/or wherein said case comprises mechanical foolproofs to ensure uniform positioning of the dial side and the back side of said calottes or said watch heads.

15. The device for testing and/or adjusting a timepiece according to claim 7, wherein each said internal sensor is a piezo sensor, and wherein each said electronic module is arranged to emit and/or receive infrared and/or other signals for triggering manipulation means for moving at least one said case and arming automatic winding mechanisms included in said horological movements contained in said case.

16. A method for testing and/or adjusting a horological movement with a device according to claim 1, according to which:
said movement is inserted into said suitable calotte, or assembled within said watch head;
said case is provided which is equipped with lower resilient elements adapted, as the case may be, to receive said calottes, or said watch heads of a given model, and the adapted upper resilient element(s);
each said calotte, or respectively each said watch head, is deposited in a compartment of said case, and surrounded by suitable resilient elements;
said cover of said case is closed by compressing the resilient elements, and each said calotte, or respectively each said watch head, bearing on said measuring support, is pressed on an edge of said calotte or respectively of said watch head;
the recommended measurement cycles are performed, and said case is manipulated in different positions in space;
for each of these positions, at least one test and/or adjustment operation is performed on said horological movement by means of an external sensor communicating with an internal sensor via a printed circuit, and/or by means of a tool.
